(19) United States
(12) Patent Application Publication
(10) Pub. No.: US 2018/0279555 A1
(43) Pub. Date: Oct. 4, 2018

(54) Esom 11

(71) Applicants: Chikezie Ottah, Dallas, GA (US); Esom Ottah, Dallas, GA (US); Ijeoma Ottah, Brooklyn, NY (US); Christy Ottah, Brooklyn, NY (US)

(72) Inventors: Chikezie Ottah, Dallas, GA (US); Esom Ottah, Dallas, GA (US); Ijeoma Ottah, Brooklyn, NY (US); Christy Ottah, Brooklyn, NY (US)

(21) Appl. No.: 15/530,963

(22) Filed: Mar. 29, 2017

(51) Int. Cl. A01D 69/02; A01D 41/12; A01B 79/00; A01B 35/32; A01B 49/04

(52) U.S. Cl. CPC A01D 69/025; A01D 41/12; A01C 7/08; A01B 35/32; A01B 49/04; A01B 79/005

(57) ABSTRACT

There is four major part of this invention, the name vehicle represent train, air plane, bike, bicycle, and wheel cart attachment unit. Again the invention have two vehicle types, the farm assembled vehicle is one and personal assembled vehicle is 2, the patent also describe the third major part of the invention as the assembled farm hoe technology, the invention also discussed the assemble of arm or arms technology. Lastly the invention discussed and illustrated the use renewable energy technology

The major parts mention seek to improve food productions with applied technology, improve speed of food production using mobile vehicle, apply the power of metal aluminum, rubber, plastic, etc.

The result is a better farm hoes technology, a better arm or arms technology, a better farm vehicles, a better personal vehicles. The technology promote autonomous farming, autonomous hoes, autonomous arm, or arms and autonomous personal vehicle.

The whole system use clean renewable energy, the clean energy make the vehicle affordable to the farmers, and make food affordable to consumers. Promote commerce.

### CLAIM PRIORITY

U.S. 62/390,732

### Patent Number

Ser. No. 15/530,963

### BACKGROUND OF THE INVENTION

The disclose invention relate to a farm new mobile vehicle, or and a personal vehicles, the invention is mainly a farm equipment technology. The invention futures verity of vehicles, and other non-traditional vehicle to satisfy the need of various farms, from grand pap or grand mam mills, to cooperative farms, to large corporate farms. The new mobile vehicle in general include ship, train, plane, vehicles, bike, bicycle may be assembled to farm vehicles and other for better choice. The invention in another main patter comprise a hoe technology, the hoe technology comprise again with arm or arms. The arm comprise motor, piston, hydraulic electronics and others. The hoe technology is technological design to cultivate and harvest crops, disinfect, fertilize, build fish and animals ponds. The vehicle and most of the devices, items and technologies uses renewable energy as a sources of power supply. The present invention is not federally sponsored research and does relate to prior art U.S. 62/390,732

### RELATED ART

U.S. Pat. No. 8,897,943 illustrated a farm vehicle, that run on a generator energy resources and engine, the system is supported by batteries, and diesel fuel.

U.S. Pat. No. 8,925,287: is a cylindrical rolls of net wrap or a solid wrap material storage machine. The farm vehicle also operate on the same generator engine, energy technology, improve on diesel fuel system.

U.S. Pat. No. 8,948,980 a vehicle for planting, improve on gas or diesel fuel, rely on the same generator engine for the farm vehicle. Added a re-due engine temperature

US. Patent: 88/742061 a farm vehicle for mopping, the vehicle also rely on the same engine mechanism

US. Patent: 20140325419; the same engine make of the farm vehicle, but added a climate control system and reuse of diesel or gas fuel.

US. Patent; 20150025708: the same engine system mention on patent 89/48980, but added is automotive.

US. Patent; 20140379196; the same generator engine, battery and diesel or gas fuel for mobility, added is a robotic mower.

US. Patent; 20140305303; the same engine system, but improve to bio-fuel system.

U.S. Pat. No. 3,683,842A; Illustrated a light brackets for farm vehicles

U.S. Pat. No. 2,530,350; illustrated how to unload from a farm vehicle.

U.S. Pat. No. 3,242,993A; illustrate mechanical traction adjuster for supplying increase traction to the driver connect to vehicle.

US. Patent; 20160147225; another farm vehicle which illustrate autopilot technology, to avoid fatigue in farm work.

U.S. Pat. No. 9,454,153 B2; Another farm vehicle which describe autopilot technology, the patent address work safety.

DK78525A; addresses farm vehicle

GB673597A; addresses farm vehicle

FR1378078A; addresses farm vehicle.

| | |
|---|---|
| BMW | Personal vehicle rely heavily on diesel or gas |
| | and do not use renewable energy like |
| | Turbine, and solar |
| HYUNDAI | The same is true of Hyundai |
| SUBURU | Accordingly, the same deficiency is true |
| | of vehicles from SUBURU |
| ROLLS ROYCE | Like wise, the same is true of personal |
| | vehicles from ROLLS ROYCE. |
| FIAT CHRYSYLER (FCA GROUP | The FCA Group vehicles are deficient |
| ABARTH, ALFA ROMEO, CHRYSLER, | because a lot of diesel, gas, are needed |
| .DOGE, FIAT, RA, SRT, FERRARS, AND | to drive their vehicles |
| MASERATI | |
| FORD | Same is true of FORD Corporation, |
| | no renewable energy, car batteries are not |
| | optional |
| TOYOTA | The is true of TOYOTA mobile vehicles |
| INTELLECTUAL PROPERTY DIV | no reserve portion for a turbine or solar. |
| 1 TOYOTA-CHO, TOYOTA AICHI | and battery is not an optional |
| 4718572 | |
| JAGUAR/LAND ROVER | The same is true to JAGUAR/LAND |
| ROVER, | vehicle. |
| NISSAN MOTORS CO. LIMITED | All the above is true of NISSAN, |
| GENERAL MOTOR COMPANY | Same is true of GENERAL MOTOR |
| DAMIER AG (MERCEDES BENZ) | All the mention above is true. |
| | of MERCEDES BENZ |
| MAZDA MOTOR | As mention above, need a recharging |
| | station |
| CITRON/PEOGEOT MOTOR COMPANY | As stated above, in the invention |
| PSG | oil pump is optional |
| SAAB MOTOR | As stated in the patent, alternator is |
| KIA MOTOR Corporation | optional Is good for our environment. |
| MITISHBUSH MOTOR CORP. | As stated in this Patent, it has the emission zero. |

### SUMMARY

36. A general assembly of various motors, machines, vacuum, hydraulic powered hosts or pipes and technologies, (Not Shown) may include other elements like piston, clips, clip board, to fix agro fish farms water or land habitants (E.G. pond, lake, River, or the Ocean). 63 assembled cleaning machine for under water cleaning and mapping, 50 may comprise: A motorized joint arms, or hydraulic, or vacuum, or technological powered arms, arms able to have axially, rotational and lateral movements with or without sensor (S), the lower part of the arms may comprise: A host. A brush. A host with a grabbing fingers. A host or brush with a tooth, A host or brush grabbing fingers fully magnetic, A host or brush grabbing fingers fully equip with sucking technologies or devices, A host or brush attached to the 55 ship assembled arms may be equipped with an attached dispenser device for farming and cleaning the farms habitant.

63. in another form, the arms comprising at the lower section (host or brush) a dispenser or under water pump technology, may include a drainage devices to expel dirty water and replace the water with clean water pumped from the 55 ship or close by water facility.

63. In another form, the 55 ship assembled arms; comprising the lower sections, may include huge number of fishing hooks, nets, baskets fishing traps, vacuums opening/pump insuction fishing. This assemble mechanism is for large agro mono crop industrial farms.

63. Alternatively, the 55 ship under water assembled upper arms maybe equipped technologies, or sensor driven motors inbuilt into the lower arm to dispense 57 fertilized fish eggs, shrimps, snails, crabs, clams or other nursed young fish into agro mono industrial farm crop.

### FACTS OF AGRO INDUSTRIAL FARM/CROP

Its capitalist venture have invested and replaced over 40 percent of extinct fish species, supply to the broad market from a controlled fish habitants to saver the natural environments, reduce pollutions, border dispute by supplying indiscrinatingly to countries. Balance the eco-systems.

In this summary of invention is right to look back at definition of an agro farm mobile vehicle, 55 a vehicle with a mobile structure, comprises of one or more 63. wheels, mounted in a shock or spring bias shock, engines, converter (3^{rd} convertion) internal confine space and seat for the users, installed technologies, computer, electronic and other manual navigational system for the user and external space for engine, and engine mount, drivers control devices, different farm equipment like a farming hoe technology and renewal energy technologies.

63. Agro industrial farm. This invention is developing a new farming vehicle with a hoe (s) to cultivate the farm in an unprecedented scale, this new vehicle with hoe technology will replace human inefficiencies, the new vehicle with a hoe technology will maximum the use of land, control waste, food inspection, safety and tagging.

63. the new agro industrial vehicle (s) are 1^{st} a farm vehicles, 2^{nd} with a minor modification may become a passenger vehicle, a private user may choose the vehicle to function as both for farm work and passenger vehicle.

63. the new vehicle, in another form, the invention preferable focus on invention of Green vehicles, the new green vehicle will advance and become leading vehicle for environments and eco-system balancing. Reduce carbon emissions, reduce lead emissions, and others. The new vehicle may not require or need oil pump machines, or other fluid pump machines, engine block may not necessary, battery or batteries are not necessary, but the owner discretion. the new green vehicle may be an autonomous vehicle.

63. Preferable, the new agro industrial vehicle comprised: an assemble of Motor mount, the vehicle structure, electric motor (or the engine). A new Green Vehicle that include train and ship may also hybrid technology.

63. the new agro vehicle assemble mechanize may include a motor mount, a structure or vehicle body, shock or spring bias shock, electric motor, transmission, converter systems, A/C compressor, one or more 55 wheels, motor belt, chain, car pull-hook-ups, starter, spark plug, 57 user confined space, passenger confined space with seat, seat belts, sensors, autonomous vehicle technology or the autonomous vehicle media exchange. Steering, gear, diluted or amended fluid. Computer and electronic systems, and other vehicle control mechanism. An engine buster technology may be added to the engine for strength, power and speed.

63 the new vehicle assemble, energy assemble mechanism comprise: 4 energy mount system and elements, solar energy panel, wind, turbine, 4 water or steam methods.

63. the new vehicle assemble, the hoe assemble technology comprise; an arms, (rising, folding, and rotational), technology bias hoes, hoes movement by motor, electronic, air (vacuum) system, hydraulic, or piston. The plurality of hoes may include any of this farming stages, hoe for clearing, soiling texturing, soil grinding, soil molding, soil mixing, soil digging, seed planting, water, Manuel, chemical or insecticide dispenser hoe. Better hoes, quick, better strength and dependable.

### Advantage of the New Agro Industrial Vehicle(s)

Eliminate pollution

Eliminate dangerous 3^{rd} rail system in train transportation, and 3^{rd} rail are prone to natural disasters

Eliminate dangerous over head rail life wires in train transportation system, prevent huge cost to tax payers.

Eliminate recharging stations for cars (electric and or hybrid cars)

Air plan; Agro industrial farms are huge farming corporation, often extend beyond many borders, cross many state lines, farms of one ownership starch beyond many countries, traveling with regular vehicles pose many challenges, problems from damage roads and bridges to institionalized laws and check points. The air plan remains the only viable means of reaching and crossing and getting from point A to point B with less time, less money to solve any farm numerous problem on time across state lines air plan logistic became better. 63. the air plan as a new vehicle for the agro industrial farms, the need for a specialized air plan for agro farm need became important, the air plan with a hoe can deliver or plant seeds, spray water, Manuel, chemical or insecticide dispenser through the hoe(s), the new agro air plan can deliver parts faster than any vehicle to avoid crops from perishing during a difficult time, like an invasion of locus, a specially designed air plan with hoe technology can eliminate the locus, another example is adverse weather, the air plan can deliver anti de-frozen chemical faster to a huge acres of farm land, while local pipe are frozen, a specially designed air plan, helicopter and others with hoes technology and renewable energy deliver de-frozen chemical a cross states line, or countries border in no time and cost less.

This invention will now be illustrated and describe by way of the embodiments, and farm will replace Agro Industrial farm.

The traditional farming continued to evolve throughout centuries, today bio-technology have created and cultured good seeds, plants and animals the earth have ever seen, apparently the world population is out growing the new designed crops, seed, plants and animals, the new feeds are not enough for human or and live stocks. Farming no longer attract labor, younger people immigrating to the urban areas left the farming to elderly and weaker hands, the result is endangering the human civilization to a breaking point. Result some animals and livestock are at extension.

The shortages or lack of crops and feed for human and live stocks, to put it simply, people do not want to farm any longer, now that lead to a new farming tools, the new farming tools or and farm vehicle engine by technology to tackle the farm problems, the new farm vehicle aim at reviving young people into farmer again, because farming still value human resource, the new vehicle, train, ship, air plan, or helicopter engine with advance technology provide greater strength ever to handle Agro Farm system, provide the greater brain ever to tackle the farm system, provide the better management ever to tackle the farm system, provide a better tools ever to tackle farm system, provide better use of land, provide better use of transportation, food distribution system, and cheapest and safest transportation for people, provide better use of energy resources, provide more food ever produce in any farm system.

Alternately the new vehicle engine by new and advanced technology is a better choice to solve the deficiencies of the previous farming tools and or mechanism. In one form the invention provide a new technological vehicle, that have equipment technologically specialized for farming in all weather, conditions, with sensor controlled programming, the new vehicle: comprised a mount. The vehicle mount comprise: a front and back areas end structures, the mount and it elements comprise at front end; units to embed the engine (s), units to embed the other motor(s), units to construct or arrange the arms or holes system, open unit(s) for energy arrangement in the vehicle, open unit(s) for light, camera(s), computer(s), command center for Sensors, command centers for electronic, unit for steering arrangement, including paddle(s) tires, chains, other wheels or break technology, it elements and control systems. Unit for balance: motorized or electronic powered vehicle lift support technology. unit(s) for mount spring or other shocks(s),

In another form the mount comprise unit(s) for the (bottom) rear side mount; comprise a conversations; multiple or single wheels conversations; sensors, computers or audio video unit mount(S); electronic, electric, chassis, control system, display screen or electronics and satellite devices unit; light units; bumper unit; electrical or power unit, (example renewable energies) less motor fluid; tires, rails, chains, fly, and or water; spring shock mount

Top mount of the vehicle is another formed structure, comprise of seat unit; dash board control command unit (s), climate control out lets unit and other climate control out lets locations, digital or analog system, remote control, touch screen, touch button and or general vehicle machines, electronics, computers, visual diagnostic, fuss connector and control or other inter-connector, connectors, spring shock mount, seat mount and technology, seat electronic, motor adjustable movement mount, seat electronic remote or button control mount.

The power unit technology: comprises of mobile solar energy converter technology, mobile wind converter machine and or technology, mobile sun energy machine or technology and converter technology system, mobile steam, or fluid energy technology and or converter system, mobile fire energy technology and converter system, mobile electronical or buster technology or converter machines, and all their elements. This above named items may be store in the best effective, efficient, safe unit in the vehicle (s).

In another alternative, the machine that move the vehicle may not be an engine configuration, or a total system base on engine, but an electronic powered engine motors system or hybrid power vehicle technology movement, or the combinations of all or some of all for better, affordable vehicle and earthly most green vehicle ever assemble on earth. Universally Adaptable in any part of the world, including the uniquely power technologies machine or systems.

### The Power Technology and Elements:

1. refueling or recharging with in 50 miles or over years optional

2. batteries, in the vehicle, train, air plan, ship optional,

3. Engine in the vehicle, train, air plan, ship optional

4. autonomous vehicle, train, air plan, optional

5. Water Pump, in the vehicle, train, air plan optional

6. Fuel pump in the vehicle, train, air plan optional

7. Alternator in the vehicle, train, helicopter optional

Agro Farming industry is going to be the new wave of farming, this form of farming encourages better use of land, among farmers it encourages better of water resources, products are screen for health reasons, better food catalog, expiration, farms are licensed, famers education and better use of machines for better result and less work time, increase revenue, medical, vacation,

This farms involve a whole cultivation of plants, crops, vegetables, animal, fish and fruits studies have found this crops, plants, vegetables and fruits does better in different climate or whether than other, example rice grow better in swamps. Equally studies have proved that machine have to be modified to be use to cultivate the land.

The 63 machine rang from users powered hoe 36 mobility 55 to wheels with engines, electric motors, and hybrid, the farming need involve all types of mobility with different horse power, weather in land way, sea way and or air way to get modern Agro Farm industries far better and more productive than the predecessors.

Agro farm industry in sea or fish farming 63 a 50 ship for agro fertilizing and planting to the 43 fish pond, lake, or street, stream, river or ocean, 55 any of the above mentioned fish 43 habitant could be natural or artificial, the on bound or aboard 100 lab. In the 50 ship is scientific evolution of the fish habitants for any infection.

For the benefit of Agro farm industry, going green may be an ideal method for ship farms, 55 an electric engine propel ship, 55 where around lower portion of the 50 ship would 63 nets 50 and or baskets ready to harvest or in plant 50 new 50 fish habitant. The new 55 ship will be navigating with advanced with the new technology, with very 4 a low energy cost, 55 the electric motor technology, maybe powered by another green technology of 4 the sun solar, or wind turbine, water or rain. Or any other arrangement mention above, should the user need demand.

36 An assemble of various technologies and machines and/or it elements for fish farming, including agro fish farm cleaning, examples are pond, lakes, rivers, and oceans, water fall and streams.

63. Assemble cleaning machines for under water clearing, 50 Comprising: a new motorized hoe, like brush, digger, grounder, or a molder, this machines are configured with arms, pistons, hydraulic, or vacuum powered machines and have cleaning control, visual inspection of the under water debris by the use of technology, computer, electronics. This process is repeated during plating and harvesting periods.

63. in another alternative form, the ship hoe technology for Agro farm may include an arm arrangements that assemble at the tip, preferably a dispenser for the chemical cleaning of the fish inhabitant from the ship.

63. in another form, the arms comprising at the lower section a dispenser, water pumping machines, or drainage system to expel dirty water and other unwanted materials out of the fish environment.

63. in another form, the 55 ship assembled arms, comprising in the lower section a hoe technology that include a motor, vacuum, piston, hydraulic lifters, or technology that enable the movements of the arm (s) and the hoes (eg net, basket, dispenser, hook etc) to feed, fertilize, inject new fish into the colony, or harvest the fish.

63. Alternatively, the 55 ship under water assembled, the upper arm (s) maybe equipped with 7 a technology based motorized upper arm, or piston, hydraulic, air or vacuum lifter. The upper arm (s) other means of movement maybe manual, to cultivate and plant the seed, dispense fish eggs, any other method necessary to fill-up the fish habitant for Agro farm system.

Advantage of the new ship (vehicle, train or air plane) in Agro farming are:

1. over 90 percent of fish or crop species have been extinct

2. the Agro technology farming the new technology vehicles, mentioned above to replace them and grow economy. And re-balance the nature.

3. As a new vehicles technology for responsible farming, the new farming vehicle, ship, train or plane uses and promote clean air technology that avoid and control pollutions

4. the new farming vehicles, air plane, ship, train or helicopter promote responsible farming vehicle (in general) of renewable energies, the benefit becomes less burning of fossils fuel, the society moving rapidly to good eco-system,

5. The new vehicles technology promote responsible farming which is verifiable by the government, business and public alike.

63. As we described vehicle (s) in this application, we in general, we imply it to mean or include other forms of mobility, like mobile vehicles, mobile bike, mobile train, air plane, ship, strapped human. Even though the invention is focused in improving Agro Farming industry, this may become an industrial spin-off to other farming processes like mobile bikes, strapped animal or human.

63. This patent recognized, and define a vehicle as a structure, a mounted mobile structure, with one, or more wheels, on a combination of springs, shocks, arms, breaks, motor, or engines, transmission, converters, renewable energy and the new hoe technology, others. The mobile 55 vehicle structures internal, confined the user (s) in a seated positions to operate, and control the vehicle activities by the use of vehicles technology, computer, electronic, steeling, or other manual means.

63. The new vehicle with hoe technology, elevate the need of a responsible commercial or private farm system, Agro industrial farming, the 55 new vehicle with hoe technology, make it possible that one to few farms have the ability to feed the world, on this patent, we shall refer to this farms as Agro industrial farms. This new vehicles (in general) have been developed with computer, electronic, or simply as hoe machine and technologies, it is tech built and design to reliability, efficiency, accuracy, more dependable than human, longer and better performance, can stand farm chemical or other treatments.

63. The new Agro industrial vehicles, the technology vehicles maybe designed in various ways but it is worth notable that the new vehicle technology will seek to develop the best environmental new farm vehicles or mobile vehicles, or a total new green vehicles.

While there may be other form of this Agro farm vehicle or new mobile vehicle, preferably the new Agro vehicle, or mobile vehicle comprise: a mobile structure, as mention above, a electric motor mount, with one or more wheels, on a combination of springs, shocks, arms, breaks, motor, conversations, compressors, renewable energy, autonomous and hybrid technology, transmission, motor belt, other belts, chain, balance lifter legs, spark plugs, connectors, clip, clip body, doors, lights, sensors, computer, electronics, diagnostics, electric, wind shield, wiper, satellite, remote control, plurality of hoe technology, 63. the green vehicle as mention above may exclude oil pump, and water pump.

63. in this patent, the energy is the nucleus of the vehicles (in general) green technology driving force, the energy 4 is purely based on renewable energy which comprised of: 4 a solar panel, solar film, metal, combination of sheets and others elements. 4 wind turbine water, rain, steam, air, and its assembled elements.

63. As described earlier, the new vehicle with hoes or farm vehicles (in general) comprise of plurality of hoes for example field cleaning hoes, soil turning hoes, soil grinding hoes, soil mounding hoes, soil mixing hoes, seed or and chemical dispenser hoes. Unlike the old farming hoe, which is consistence of one manual arm, the farm or user use to cultivate the ground, the new vehicle hoe, solve the deficiency by having one or more arms, which may be manual, and/or technology powered hoe (s), the farmer or the user direct the vehicle with the hoe technology to do the physical labor, the machine have the power to break and cultivate more land, faster than 10,000 farmer with the old hoe, the new vehicle (in general) with the hoes technology can clear the farm land, cultivate the farm mold the farm, sow the seeds, mix and spread the manure 10,000 times faster than the farmer.

63. The new farm vehicles (collectively) comprise of plurality of hoes, the hoes comprised of arms, the upper arm, conjoined, or connected by other (element) connectors to one or more lower arm (one or more arm). One assembling type, the upper side of the arm attached to the vehicle, mount, slot, or jack, the upper section of the arm lock into the vehicles mount, slot, jack, or other opening and secured in position for cultivation, the arm may use technology like a motor, piston, air, vacuum, or hydraulic or others power electronic or machine to flex the hoe into farming, other method of assemble.

63. The new vehicle with the hoe technology have (collectively a car, train, ship, air plane) solve the deficient of the old system of farming.

1. the new vehicle with hoe technology eliminate Farmers dependency on fossil fuel and reduce cost

2. one to few farmers with the new vehicle with the new hoe technology can feed a country

3. the new vehicle have solve the need for a charging station, eliminate the cost

4. Another deficiency the new vehicle solve is the use of 3^{rd} rail, the train have no need for a 3rd rail system because the new train uses 4 a renewable energy.

5. The new vehicle solve another deficiency, the train do not have to use coal or diesel to pollute the atmosphere because the new train with hoe technology is equipped with renewable natural clean energy.

6. The new vehicle solve another deficiency by eliminating hang out side dangerous live electrical wiring and the cost.

7. The new vehicle with hoe technology, solve another deficiency by eliminating lead that fall from air plane.

### BRIEF DESCRIPTION OF THE DRAWINGS

FIG. 1, is a perspective view of the present invention

FIG. 2, is a schematic view of the embodiment of the present invention.

FIG. 3, is an exploded view of the embodiment of FIG. 3, illustrating vehicle with a renewable energy

FIG. 4, is a perspective view of the present invention according to FIG. 4. in collaboration with other new vehicle.

FIG. 5, a side perspective view according to FIG. 5, illustrating a train hoe technology FIG. 6, a side view of a new vehicle assemble, illustration a clip body means of the hoe technology

FIG. 7, is a top view of a new vehicle assemble, according to the embodiment of the present invention

FIG. 8, an explosive side view of a new vehicle assemble, demonstrating alternative arrangements of the hoe technology.

FIG. 9, a side top view of the new vehicle assemble, demonstrating alternate farming process.

FIG. 10, a side view of the new mobile vehicle assemble, demonstrating climate related arrangement

FIG. 11, a top perspective view of a new ship assemble, according to climate modification of renewable energy.

FIG. 12, a top and side view of a new train assemble, illustrating a remote, or technology modified renewable energy.

FIG. 13. Illustrate a side view of the embodiment of FIG. 13, shown in the top front of the train is a technology to read the level of power stored or leased from the renewable energy sources.

FIG. 14. Illustrate a top view of a new farm vehicle pulling a wagon with multi farm hoe technology.

FIG. 15. Is a perspective view of the embodiment of the prior art.

FIG. 16. is the elevated view of FIG. 16 embodiment

FIG. 17. Is a front view of a new hoe technology

FIG. 18. Illustrate a top view of a new hoe technology, showing the motor

FIG. 19. A front view of a new hoe technology, according to the embodiment of FIG. 19 illustrating a computer or electronic system and renewable energy system.

FIG. 20. A top view of the prior art

FIG. 21 front view of the assembling elements of the embodiment of the new hoe technology, to be mounted for mobile farming or hand held

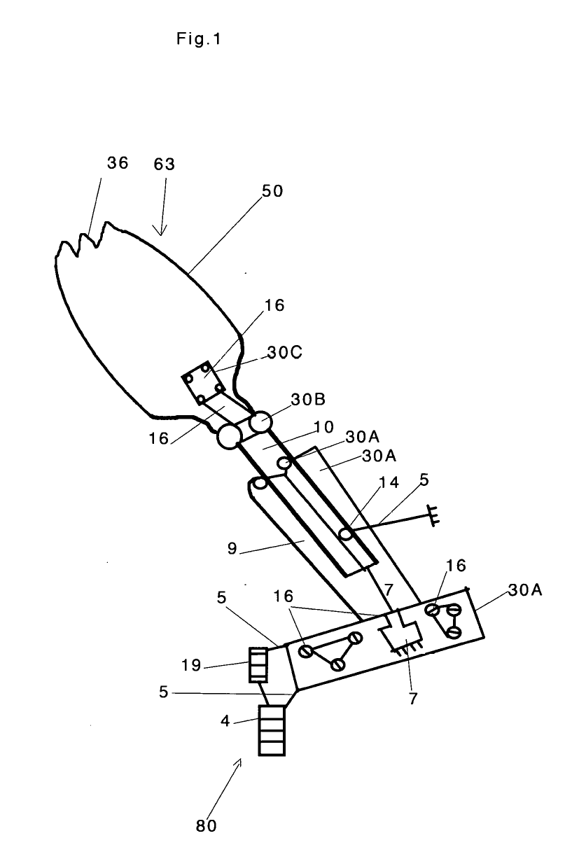

FIG. 1 illustrating 55 a new vehicle (s), the 63 new vehicle(s) features some very important 80 life changing technologies 60. The new vehicle(s)

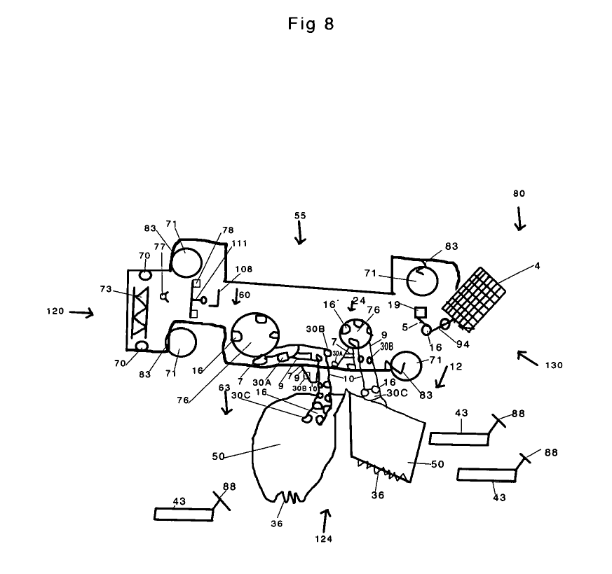

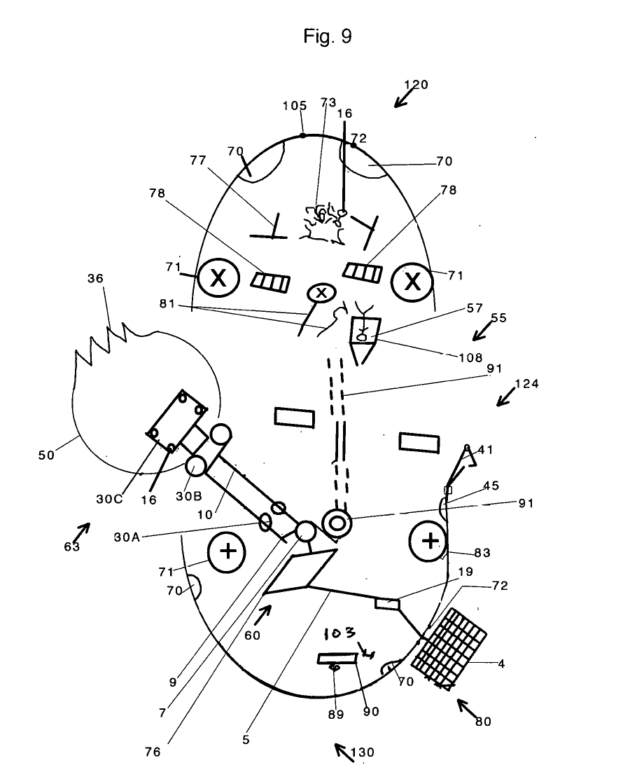

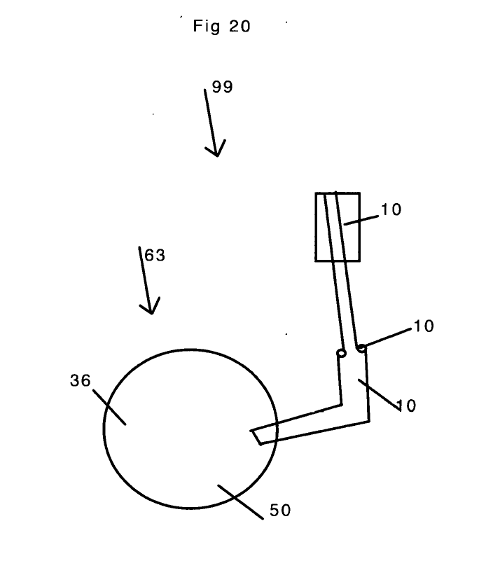

FIG. 1, 63 illustrating one of the features in a new vehicle. (new vehicle not shown). The illustrated is a perspective view of the new hoe technology and 99 a top view of prior art (See FIG. 20) farm hoe. 63 the new hoe technology 60 is enhance or 80 powered by a motor, it will be appreciated that other technologies like piston, hydraulic, vacuum, computer, electronic, or electric machine may power the hoe to cultivate the farm land, with a shift round the clock, it will be appreciated that the new hoe technology may be manual or autonomous when engineered into the new vehicle, see FIG. 8 and FIG. 9.

As 60 illustrated in 36 in FIG. 1. The new hoe technology 50 maybe of any size and shape, during agricultural farm land 43 cultivation the hoe pressure to the 43 farm land depend on the programming of the technology if the new hoe 36 is mounted in a new autonomous vehicle, it will be appreciated there maybe a user manual buttons if the need comes.

Continuing in FIG. 1, 63 illustrated 36 is assemble and design of the new hoe technology, 50 at the top end 16 is a connector or bracket, 16 screwed 36 to the hoe top 50 end, the same 16 connector (bracket) at 30c the other end have a loop to flexible clip to the 30b lower end of the 1^{st} 9 arm, the upper end 1^{st} arm is clipped to the lower end 30a of the 2^{nd} 10 arm, the 10 upper end of the 2^{nd} arm is then attached to an 7 electric motor, or the likes, for example 7 motor, piston, air, vacuum, or hydraulic or others power electronic machine to flex the hoe into farming, the 36 hoe can perform any or all the 43 farming activities the farmer need including drilling, grinding, clearing, dispensing manual, water, chemical, 43, cultivating in hips of the farm land.

As illustrated 36 the 80 energy that power the new hoe technology 4 is transmitter 19 from one of renewable energy sources, 4 sun, wind, water, rain (examples are solar, or turbine The 4 energy power the 7 motor, piston, air, vacuum, hydraulic, electric or electronic to move the arm, (the arm maybe one or more) axially, vertical, horizontal, (any type of movement to unearth the land for agricultural farming) it will be appreciated that other method to archived farm with the new hoe technology maybe apply.

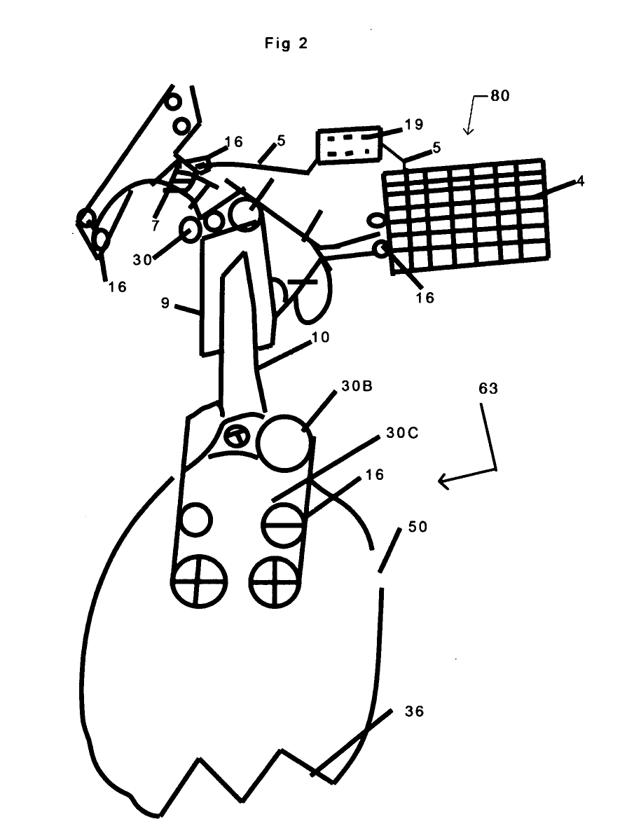

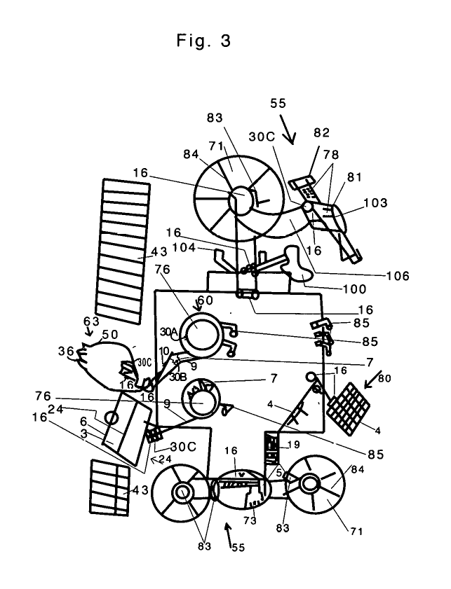

FIG. 2. Illustrate 55 again the new feature of the new vehicle (new vehicles, not shown, see FIG. 3-9). The 63 assembling process illustrate 36 an adequate designed new hoe technology, 36 the device, 50 at upper end 50 the new hoe is a specially designed 16 bracket rather 30c clip in a bend loop or other means, onto 50 the upper end of the 30c new hoe technology. A lower end 30b of the 1st arm is attached 30c to the upper end of 50 the new hoe 16 in a flex nut for stability of 36 of the new hoe, the 30c the flex section 30b allow 36 the free 7 coordinated or technological programmed 43 farming. (Examples, the auxiliaries, up and down movement. See the demonstration on FIG. 2, Paragraph 4) The 9 upper end of the 1^{st} arm is attached to 30a the lower end of the 2^{nd} arm 10 In a flex bond for a similar coordinated or technological programmed move 36 of the hoe farming activities. The upper end of the 10 2^{nd} arm is clipped the 7 motor, it will be appreciated that the upper 7 end may assemble other machines like a vacuum, hydraulic, piston, renewable energy, electric or computer electronic devices, sensors, satellites, GPS, ETC.

As illustrated 80 in FIG. 2, it will be appreciated that the assemble process include a mobile clean energy sources to power the new farming hoe technology, the clean 4 energy sources include a mobile solar, turbine steam, etc. it will be appreciated the economical impact and relief to farmers this renewable energy sources. This mobile renewable energy source delivers current through 5 wires or cable to 19 a transmitter, or transistor or break circuit system (analog or digital).

The 80 the mobile 4 energy provide power to the new hoe assemble, or (any configuration of the arms or devices) 7 to the motor (see the above paragraph), the motor with a sensor or without a sensor coordinate the motion of the 9 arms to the 36 hoe up, down, swing, cycling, digging, shoveling, drilling, picking clearing, and other farm need.

FIG. 3, illustrate a new 55 mobile vehicle, the new 55 vehicle or new a motor bike technology tend to introduce 63 one or more modern futures (see Paragraph FIGS. 1 and 2) to solve the deficiencies of mobile vehicle today and provide an alternative vehicle according to the embodying of FIG. 3. It is 55 a front 120 view of the new vehicle, the 120 front, below the motor mount, 84 wheel, or tire, at the lower section holding the wheel, an arm, 83 is the shock or spring, attached close is the 106 is the configuration of the converters 81 systems running from the 73 engine like transmission, at 120 the front 55, above the motor mount, the 55 new vehicle is showing a 70 light on the top structure, the 73 engine, 107 a windshield, attach to the structure is a 77 wind shield wipers or and the fluid dispenser. The interior to 55 the structure of the new vehicle is the vehicle control devices, 82 the steering, the computerized 81 steering equipped with electronic buttons, the 78 dash board unit is equip with advanced technological improved digital computer and electronic visual 55 vehicle control system. Climate control, 100 attached to the user is a seat with seat beat, and 100 seat adjustment control button and front 104 break or hand break paddles.

FIG. 3. Illustrating the 55 new vehicle, in the 124 embodiment, at the 124 middle section of 55 the new vehicle is mounted 63 the new hoe technology, the new hoe technology is a newly designed 36 hoe technology for farm, the 36 new hoe at the lower end of the 36 hoe is design to dig-up, grind, clearing the 43 farm, the new 36 hoe could one or multiple numbers, 36 in many design to meet all agricultural need, a rice farm need, a yam farm need, a corn farm need, a potatoes farm, a fish farm, or animal farm.

The 50 new hoe at the upper end is attached or clipped 16 a bracket (other connectors) in flex connected 1^{st} end of a bracket, at 16 the 2^{nd} other end of 30c the bracket or other connector is connected, or clipped flexible, loop shape 30b of lower end of the 1^{st} arm, then the upper end 9 arm of the 1^{st} arm 9 is attach to the lower end of the 2^{nd} arm, the upper end of the 2^{nd} 10 arm is attached to the motor, it will be appreciated that the machine motor is collectivized device, see FIG. 2.

As mentioned 60 earlier and illustrated in FIG. 3, and seen in the 124 middle of the 55 new vehicle or new motor bike cycle, standing adjacent to 63 the new 36 hoe is a 2^{nd} 21 new hoe technology, the 2^{nd} hoe 6 is design 21 to mould the farm 43 bed for special crops, it will be appreciated to those learned or skilled in the art that the arrangement 9 of the arm 10, the arrangement of the 16 of the connectors, brackets, (inter connection of the nuts and screws) are similar, the 7 machines like electric motor, sensor or piston etc, are the same, see FIG. 2. the new hoe technology maybe mounted in any 55 part of the new vehicle.

FIG. 3, illustrated in the 80 embodiment of the FIG. 3, is 55 the new vehicle 130 rear view, the rear view according to this embodiment 4 is located the renewable energy, the renewable 4 energy sources like solar mobile energy, turbine mobile energy and the elements, 4 stream mobile energy and elements, heat energy and element, or water, the current is 5 wired or cable into a 19 transmitter, transistor, meters electric panel, or step down or step up. The 4 energy current generated 80 by the renewable source powers the new vehicle, the new farm hoe (s), including farm house. 130 the rear end of the new vehicle are 70 lights, the 71 back wheels, 83 the new vehicles shock, 90 truck

The new vehicle 73 may have any engine but it will be appreciated that 73 an electric motor engine is preferred, the electric motor engine does not require an oil pump, no water pump, charging station not necessary, the mobile renewable 4 energy and it elements is supplier of energy to the new vehicles.

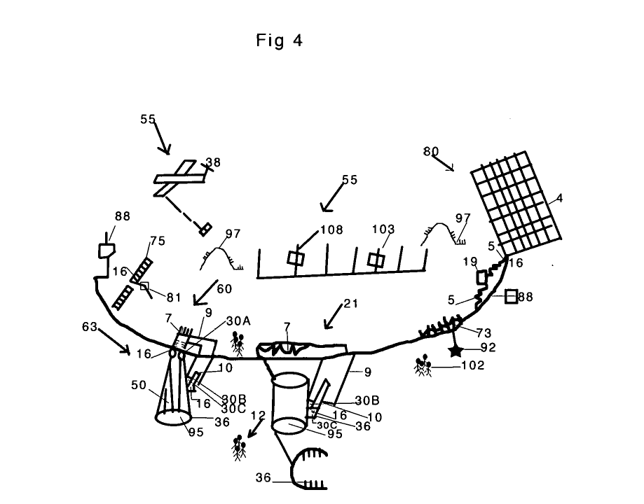

FIG. 4, like FIG. 3. FIG. illustrate a new ship, at 120 the front top is the new ship 88 modern communication unit, computer, electronic, which include 88 laser, satellite, radar, GPS. Closely link 78 together, function and inter exchange 88 media is 78 the dash board, the dash board is the media 88 command center, equipped all 78 the electronic and manual buttons, autonomous technologies talk to each other, the autonomous technology may take over the ship 24/7 43 farming if necessary. It will be appreciated that the fish farms include farms in the Oceans, rivers, streams, lakes, and ponds, 55 one or few ships may have the 88 technologies to manage 43 the fish farms and turn out huge amount of fish (Not Shown) every quarter of the year or so with help of the technologies mention above. (See the recognizes collaborating navigational assistance by an air plan to a farm vehicle or ship as described in the FIG. 4 brief description of FIG. 4)

FIG. 4, demonstrated in the 124 middle section of the 55 ship, there 86 illustrated a long sections of the 55 the ships seating areas, at the 124 middle section of the ship 103 established the 103 climate control, leading in and out is the 97 egress.

FIG. 4, 80 illustrate the fish farm ship 4 renewable 130 energies like mobile mount elements 16 and clips for 4 solar panels, turbine Steams, heat, ETC. the 4 renewable energies supplies the 4 power or currencies ship. It will be appreciated to learn that the 4 energy is circulated by circuit breaker 5 or wire, or cable wired into 19 transmitter or transistor, No pollutant like Kerosene, or hazardously wiring from outside, hazardous over head wiring of cables to recharge the ship. FIG. 4, illustrated at the 130 low rear end of the ship 73 is one or more ship preferably electric engine (s). the rear end of the ship 88 is equipped with technologies for media exchanges.

FIG. 4, 60 shown the under-water hoe technology assembly or configuration, it will be appreciated that the 4 renewable sparks the energy that powers the 7 motor, piston, vacuum, hydraulic machines, ETC. 7 the motor mounted and 16 clipped to the ship 60 mount by it elements, 7 is attached to the hoe technology at 10 the upper end of the 2^{nd} arm, 30A the lower end of the 10 upper arm is clipped to upper end 9 of the 1^{st} arm, the 30B lower end of the 1^{st} 63 arm is attached to the 50 upper end of the hoe flexible 16 bracket 30c, it will be appreciated that could add more or less electrical cables, motors, pistons, vacuums, baskets hooks, net, other dispensers water inn or out, even building a mud pond for cat fish farm, the choice of the hoe is the advanced mobile hoe technology (see FIG. 1).

FIG. 4, illustrate another new ship apparatus to improved fish 12 farms, the new hoe technology shown 21 is special in raising and harvest cat fish farm, to build the 43 muddy habitant 7 the motor is mount in the 55 new ship under water motor mount, the motor connected 5 via cable to renewable 4 energy supply, 7 the upper end of 2^{nd} arm clipped to bear in 10 a flexible 16 connector of the motor, piston, vacuum, hydraulic, etc. Then the lower end 10 of the 2^{nd} arm clipped 30A to the flexible bearings of the flexible bearings of 9 of the upper end of the 1^{st} arm, then the lower end of the 1^{st} arm in flexible bearing pluralities of connector is 16 clipped 30B, to 30C upper end 50 of the hoe technology. It will be appreciated that the flex bearing of the joints allow the nature of the up and down, cycle, movements. The rest of the parts can be increase or decrease.

FIG. 4, 55 illustrated a far flying air craft, and described in the brief description of the embodiment of FIG. 4, inspection the fish 43 farm, and exchanging of media.

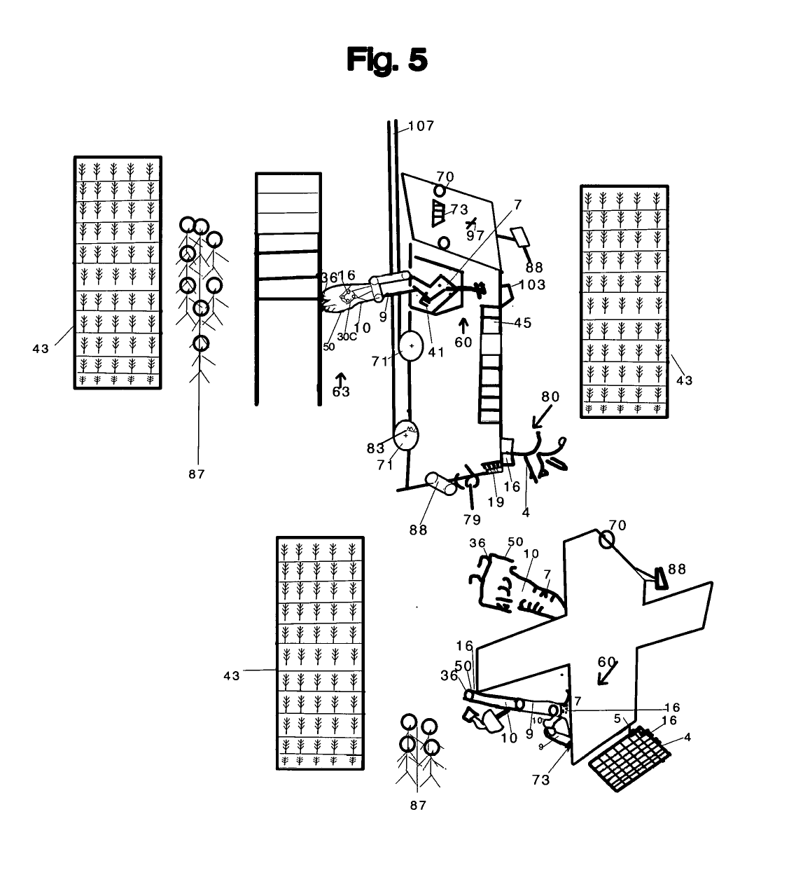

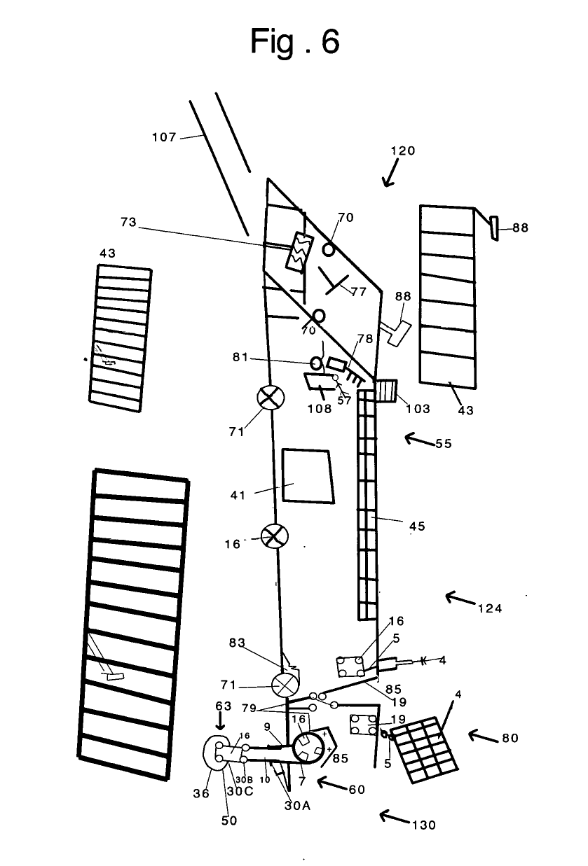

FIG. 5, illustrated in 55 the embodiment of FIG. 5 is a new train, 120 beginning from the front of the train is the 120 mount to the structures, the engine 73 could be any style engine, but preferable engine 73 is electric motor, there 70 is a pair of lights, at the 107 wind shield is the 77 wind shield wiper, 55 at the top of the new train is mounted and 16 for solid is 88 the train navigation sensors technologies. Beside 88 electronic and computer navigators, is 103 the compressor or air conditional system, closely located 45 are numerous locked or opened windows.

The patent also illustrate 130 at the top end of the rear end of the train 80 is mobile mounted and clipped to the train 16 with its elements are 4 the renewable energy (power station). Like 4 the wind turbine, Sun solar system, water, heat, steam energy turbine. It will be appreciated that the 55 train car shown on FIG. 5, may be one 79 car or many joined cars, pull together for larger farming, harvest, distributing goods, transporting people and goods. The 55 train 4 power station which could deliver well above 600 watts of electric power, 19 have transmitter, 19 or transistor which reduces the currents in the 5 cables feed other appliances.

As illustrated in FIG. 5, 55 the train 88 maybe equipped with autonomous 88 technologies for around 43 the clock farming, (see FIG. 5 the brief description of the FIG. 5. An air plane inspecting) an air plane is called in to inspect the farm for potential troubles and telecast commutation or media to the train or the main office. Further below the rear 130 end of the 55 train is illustrated the 71 train wheels, 83 the shocks, the 41 door way is located 124 in the middle of the 55 train.

FIG. 5. Illustrating and demonstrating the 60 assembling of hoe technology 63 in a farm action 36, the cultivated layers 43 of farm bed, the mobile 55 train could be autonomous or operated by a farmer (not shown). The description of the hoe technology, the motor mounted are 16 clipped to the train 60 mount by it elements, 7 is attached to the hoe technology at 10 the upper end of the 2^{nd} arm, 30A the lower end of the 10 upper arm is clipped to upper end 9 of the 1^{st} arm, the 30B lower end of the 1^{st} 63 arm is attached to the 50 upper end of the hoe flexible 16 bracket 30c, it will be appreciated that the assembling could add more or less electrical cables, motors, pistons, vacuums, baskets hooks, net, other dispensers for water in or out, even building a mud pond for cat fish farm, the choice of the hoe is the advanced mobile hoe technology (see FIG. 1).

As illustrated in FIG. 5, an exploded side view of the FIG. 5, a distance farm 43 (s) under attack by some party of 87 locus, the 87 locus attack have unfortunately spread to other farms, the collaboration 55 of the (land farming) 88 technologies and exchange of media (air plane with the chemicals) between the 55 train and air plane to locate an vanquish the 87 attacking locus faster, with chemicals and eliminate any effect of the chemical on human.

FIG. 5, illustrated the air plane challenges to one of the many attacks, a perspective side view of a farm under attack is seen, and demonstrated is the responding 55 air craft, in the 120 front is the 70 light, the air plane engine, preferable electric durum engine, (Not Shown). At the top 124 tail end of the plane 80 is the renewable energy. it will be appreciated that the assemble process include a mobile clean energy sources to power the new farming hoe technology, the clean 4 energy sources include a mobile solar, Tobin turbine steam, etc. it will be appreciated the economical impact and relief to farmers this renewable energy sources. This mobile renewable energy source delivers current through 5 wires or cable to 19 a transmitter, or transistor or break circuit system (analog or digital the motor mounted and 16 clipped to the air plane 63 mount by it elements, 7 is attached to the hoe technology at 10 the upper end of the 2^{nd} arm, 30A the lower end of the 10 upper arm is clipped to upper end 9 of the 1^{st} arm, the 30B lower end of the 1^{st} 63 arm is attached to the 50 upper end of the hoe flexible 16 bracket 30c, it will be appreciated that could add more or less electrical cables, motors, pistons, vacuums, baskets hooks, net, other dispensers water in or out, even building a mud pond for cat fish farm, the choice of the hoe is the advanced mobile hoe technology (see FIG. 1).

FIG. 6, illustrate a 55 train, the case of food shortages in the world today, FIG. 6, is very important because agriculture sector use to employ over 90 percent of world employment and produce 100 percent of world food, today there is decline in both food and or employments. Technology would change that, the new train would put back the decline In employment, raise food and service or and industries, FIG. 6, illustrated 55 train may not have the autonomous technology, the train maybe capable of self, or person driven train.

Illustrating in FIG. 6, starting from 120 the front of the body of the 55 train is the 107 rail, the 70 head light and others, at the 120 front of the 1^{st} vehicle or car of the 55 train is mounted a 77 pair of wipers, on top of a wind shield, the wind shield have an in built system monitor or a TV display that can receive media, or exchange media, or other technology. At a 120 front view of the 55 the train below the 70 light is the hood of the 73 engine, the 73 maybe a specially engineered engine that is power full to use all the technologies embody into the new train for farming. (FIG. 5 for farming technology). Illustrating from the side view 120 of the front is shown the new 55 train controller or driver of the new 55 train, as the new 55 train supply all the power the farm equipment need to grow more agricultural food. At the top view of the 120 front of the new train is a 88 tracker, radar, satellite, GPS, laser, amplifier, sensors, wireless or wired.

FIG. 6, illustrating from the top view of the 124 body of the new train are 103 the climate control systems and vents, the 45 windows of the new 55 train can be seen on the top side of the body of the new vehicle, the 124 body of the new vehicle is illustrated a 41 door, (egress). Under the 124 body is shown a 71 wheels or tires that enable the movement of the new train from station or farm to station or farm. It will be appreciated to note that the 71 wheels may kneel for rising 71 tires in some road condition, or adverse road condition. (not Shown). The new 55 train wheel are assembled 16 by bolt, screws, nuts and other elements. 71 the new train futures can be engineered located in any part of the body.

FIG. 6. Demonstration at the 130 back of the new train are the renewable energy. The patent also illustrate 130 at the top end of the rear end of the train 80 is mobile mounted and clipped to the train 16 with its elements are 4 the renewable energy (power station). Like 4 the wind Tobin, Sun solar system, water, heat, steam energy. It will be appreciated that the 55 train car shown on FIG. 5, may be one 79 car or many joined cars, pull together for larger farming, harvest, distributing goods, transporting people and goods. The 55 train 4 power station which could deliver well above 600 watts of electric power, 19 have transmitter, 19 or transistor, electrical panel distributing systems which reduces the currents in the 5 cables feed other appliances.

Illustrating and demonstrating the 60 assembling of hoe technology 63 in a farm action 36, the cultivated layers 43 of farm bed, the mobile 55 train could be autonomous or operated by a farmer (not shown). The description of the hoe technology, the motor mounted are 16 clipped to the train 60 mount by it elements, 7 is attached to the hoe technology at 10 the upper end of the 2^{nd} arm, 30A the lower end of the 10 upper arm is clipped to upper end 9 of the 1^{st} arm, the 30B lower end of the 1^{st} 63 arm is attached to the 50 upper end of the hoe flexible 16 bracket 30c, it will be appreciated that the assembling could add more or less electrical cables, motors, pistons, vacuums, baskets hooks, net, other dispensers for water in or out, even building a mud pond for cat fish farm, the choice of the hoe is the advanced mobile hoe technology (see FIG. 5). It will be appreciated that the new 63 hoe technology may be engineered and assembled in any section of the new 55 trains body or in each cars, may include hoes for clearing, cultivating, dispensing and mixing manual to the soil, dispensing seed, drill the soil, texturing or grinding the top soil, this hoes or arms of the hoe maybe engineered in a special arrangements to be effective on each farms need.

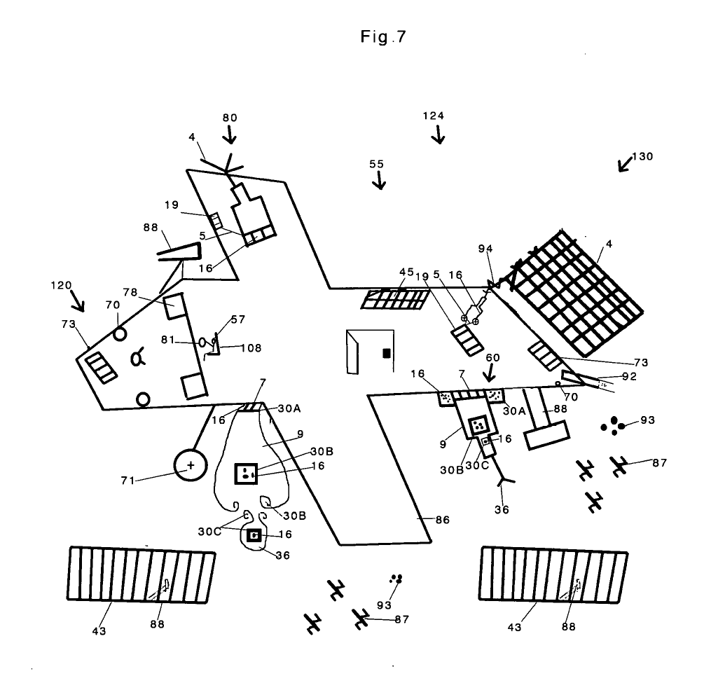

FIG. 7. starting from 120 the front of the body of the 55 Air plane is the 70 head light and others, at the 120 front of the 1^{st} vehicle or car of the 55 new Air is mounted a 77 pair of wipers, on top of a wind shield, the wind shield have an in built system monitor or a TV display that can receive media, or exchange media, or other technology. At a 120 front view of the 55 the plane below the 70 light is the hood of the 73 engine, the 73 engine maybe a specially engineered engine that is power full to use all the new technologies embody into the new air craft for farming. (FIG. 5) for farming technology).

Illustrating from the side view 120 of the front is shown the new 55 air plane controller or driver of the new 55 air plane as the new 55 air plane supply all the power the farm equipment need to grow more agricultural food. At the top view of the 120 front of the new air plane is a 88 tracker, radar, satellite, GPS, laser, amplifier, sensors, wireless or wired, this technology maybe switched to be monitored 88 dash board

FIG. 7, illustrating from the top view of the 124 body of the new train are 103 the climate control systems and vents, the 45 windows of the new 55 train can be seen on the top side of the body of the new air plane the 124 body of the new air plane is illustrated a 41 door and 89 lock (egress). Under the 124 body is shown a 71 wheels or tires that enable the movement of the new air plane from airport or farm to airport or farm. It will be appreciated that the air craft maybe equipped with a power cameras to inspect the farm and report back for quick intervention to save the crops or farms (see FIG. 5)

FIG. 7, Demonstration at the 130 back of the new air plane are the renewable energy. The patent also illustrate 130 at the top end of the rear end of the air plane 80 is mobile mounted and clipped to the train 16 with its elements are 4 the renewable energy (power station). Like 4 the wind turbine, Sun solar system, water, heat, steam turbine energy. It will be appreciated that the 55 new air plane may have other environmental favored engines also assembled in the back. (engines with no lead, or other pollution).

FIG. 7, the motor mounted and 16 clipped to the air plane 60 mount by it elements, 7 the motor or piston is attached to the hoe technology at 10 the upper end of the 2^{nd} arm, 30A the lower end of the 10 upper arm is clipped to upper end 9 of the 1^{st} arm, the 30B lower end of the 1^{st} 63 arm is attached to the 50 upper end of the hoe flexible 16 bracket 30c, the new air craft will 93 dispense the chemical on the crops destroyers. It will be appreciated to learn that the mount will fix in a base the lower end portion of the upper arm to the air craft (motor, piston or others).

FIG. 8, is demonstrating a new 55 vehicle from 120 the front of the body of the 55 new vehicle is the 103 air condition compressor, the mounted 111 steering, the 70 head light and others, at the 120 front of the new vehicle or car are the 55 new vehicle mounted 77 pair of wipers, on top of a wind shield, the wind shield have an in built system monitor or a TV display that can receive media, or exchange media, or hold other technology. At a 120 front view of the 55 the new vehicle below the 70 light is the hood of the 73 engine, the 73 engine maybe a specially engineered engine that is power full to use all the new technologies embody into the new vehicle for farming. (FIG. 5) for farming technology). And transportation.

FIG. 8, Illustrating the 55 new vehicle, in the 124 embodiment, at the 124 middle section of 55 the new vehicle is mounted 63 the new hoe technology, the new hoe technology is a newly designed 36 hoe technology for farm, the 36 new hoe at the lower end of the 36 hoe is design to dig-up, grind, clearing the 43 farm, the new 36 hoe could one or multiple numbers, 36 in many design to meet all agricultural need, a rice farm need, a yam farm need, a corn farm need, a potatoes farm, a fish farm, or animal farm.

The 50 new hoe at the upper end is attached or clipped 16 a bracket (other connectors) in flex connected 1^{st} end of a bracket, at 16 the 2^{nd} other end of 30c the bracket or other connector is connected, or clipped flexible, loop shape 30b of lower end of the 1^{st} arm, then the upper end 9 arm of the 1^{st} arm 9 is attach to the lower end of the 2^{nd} arm, the upper end of the 2^{nd} 10 arm is attached to the motor, it will be appreciated that the machine motor is collectivized device, see FIG. 2.

As mentioned 60 earlier and illustrated in FIG. 8, and seen in the 124 middle (body) of the 55 new vehicle, 9 standing adjacent to 63 the new 36 hoe is a 2^{nd} 21 new hoe technology, the 2^{nd} hoe 6 is design 21 to mould the farm 43 bed for special crops, it will be appreciated to those learned or skilled in the art that the arrangement 9 of the arm 10, the arrangement of the 16 of the connectors, brackets, (inter connection of the nuts and screws) are similar, the 7 machines like electric motor, sensor or piston etc, are the same, see FIG. 2. the new hoe technology maybe mounted in any 55 part of the new vehicle.

FIG. 8, illustrated in the 80 embodiment of the FIG. 8, is 55 the new vehicle 130 rear view, the rear view according to this embodiment 4 is located the renewable energy, the renewable 4 energy sources like solar mobile energy, turbine mobile energy and the elements, 4 stream mobile energy and elements, heat energy and element, or water, the current is 5 wired or cable into a 19 transmitter, transistor, meters electric panel, or step down or step up. The 4 energy current generated 80 by the renewable source powers the new vehicle, the new farm hoe (s), including farm house. 130 the rear end of the new vehicle are 70 lights, the 71 back wheels, 83 the new vehicles shock, 90 truck

The new vehicle 73 may have any engine but it will be appreciated that 73 an electric motor engine is preferred, the electric motor engine does not require an oil pump, no water pump, charging station not necessary, the mobile renewable 4 energy and it elements is supplier of energy to the new vehicles.

FIG. 9, the new vehicle as described in many ways among so many engineered improvement, want to solve catastrophic public health problem associated with old vehicle emission. starting from 120 the front of the body of the 55 train is the 103 air condition, the 70 head light and others, at the 120 front of the new vehicle or car, is mounted a 77 pair of wipers, on top of a wind shield, the wind shield may have an in built system monitor or a TV display that can receive media, or exchange media, or other technology. At a 120 front view of the 55 the train below the 70 light is the hood of the 73 engine, the 73 maybe a specially engineered engine that is power full to use all the technologies embody into the new vehicle for farming (see FIG. 8). Inside the new vehicle are 78 dash board, include the new 55 vehicle 81 peddles, control buttons, and 111 steering.

FIG. 9, the motor mounted and 16 clipped to the air plane 60 mount by it elements, 7 the motor or piston is attached to the hoe technology at 10 the upper end of the 2^{nd} arm, 30A the lower end of the 10 upper arm is clipped to upper end 9 of the 1^{st} arm, the 30B lower end of the 1^{st} 63 arm is attached to the 50 upper end of the hoe flexible 16 bracket 30c It will be appreciated to learn that the mount will fix in a base the lower end portion of the upper arm to the vehicle (motor, piston or others). As illustrated in FIG. 9, at the 124 middle of the body of the vehicle is 91 the transmission (or the 3^{rd} conversation, two 81 seats, the two seats are located close to the 41 door, and 45 the window. The hoe technology as seen from the 76 base have the ability to 76 rise, rotate, move horizontal, vertical to position the hoe in a proper farming position and effective blend of the 36 hoe (s). other march 36 hoes may be insect into the arm 30c, at the lower end of the 1^{st} arm.

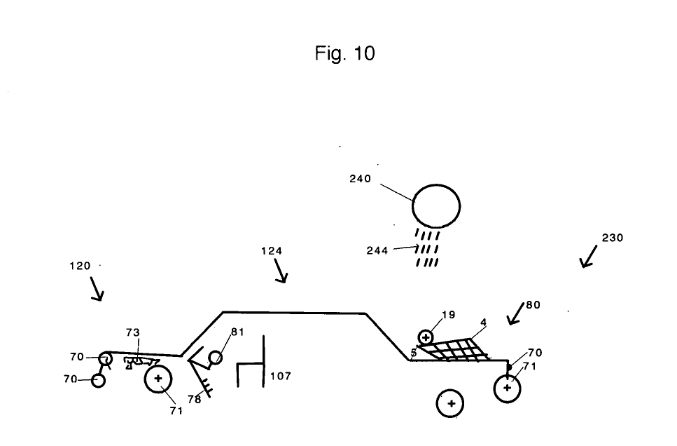

FIG. 10, illustrating a new mobile vehicle, (see FIG. 3 and FIG. 6) 120 the front section of the new vehicle is 70 equip with lights, the illustrating 73 motor engine or an electric engine with partial or full engine parts, the new vehicle is equip 71 with tires, and or motor shocks, connected motor arms, transmission, or converts (not shown). FIG. 10, 124 the upper section of the view illustrate. The wind shield, wipe, sensor for exchange of media, (see FIGS. 5 and 6), 124 in the low side view of FIG. 10, demonstrate 83 a technology improved dash board, vehicle steeling, below the steeling is the vehicle break, gear or acceleration, 124 further inside the vehicle are seats.

124 illustrating at the top view of the embodiment the season, we will appreciate the understanding of 244 the challenges the 240 weather poses, 240 the adverse climate 244 area may include additional parts like batteries or others. (See FIG. 10 at 73), FIG. 10, illustrated in it embodiment 124 a side top 240 view of the invention, the 80 new vehicle renewable energy, (see FIGS. 1 to 9).

The illustrated 244 weather result 240 in low, limited sun energy for 24 hour, this may 4 lead to other arrangements, include added battery or other partial motor parts, 80 this additional weather rearranges may be limited to adverse, or harsh fall climate.

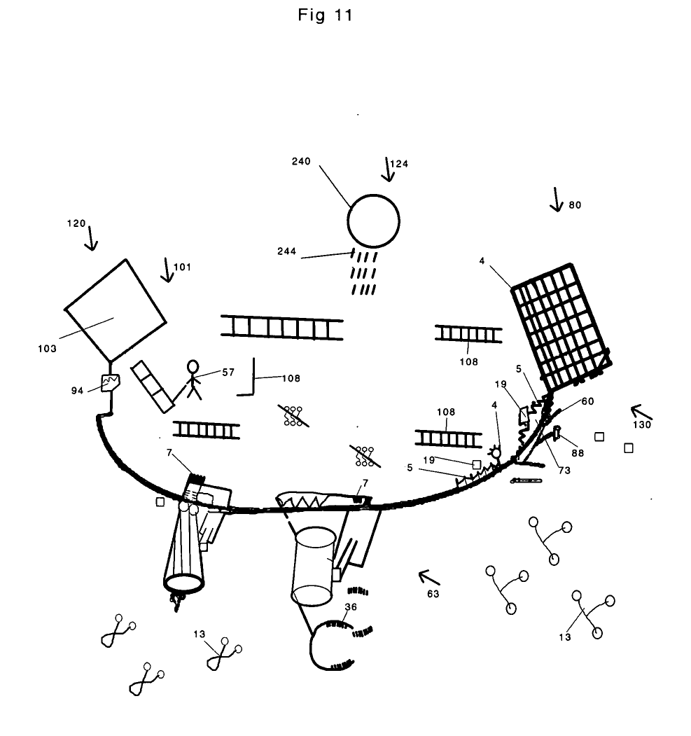

FIG. 11, demonstrate a mobile ship, 120 at the front of ship is the deck, 83 including the ship dash board, 120 continuing on the front section is the ship steeling, (see FIGS. 4 and 5) The mobile ship, 124 continuing in the middle section of the ship is 41 the egress, by the side of the doors is located the engine, the engine may contain 240 arrangement due to server weather condition, we will appreciate the under stand 240 which maybe warranted by challenges of the weather, the challenges of weather, for example adverse 244 cloud conditions, may require extra technology, or parts to the motor engine to function fully, further the added technology may include remote control, computer, electronic system to relocated the renewable energy supply (manual or self driven engine, or GPS) the arrangement may 73 comprised of battery, improved cylinder system, and others.

FIG. 11, continue to illustrate a mobile ship, demonstrate the renewable energy, 130 at the rear view of the ship, the 4 renewable energy (a wind turbine or others) is 5 connected to an electrical panel, transmitter, and others. Illustrated 130 behind the ship is a fish 43 a pond.

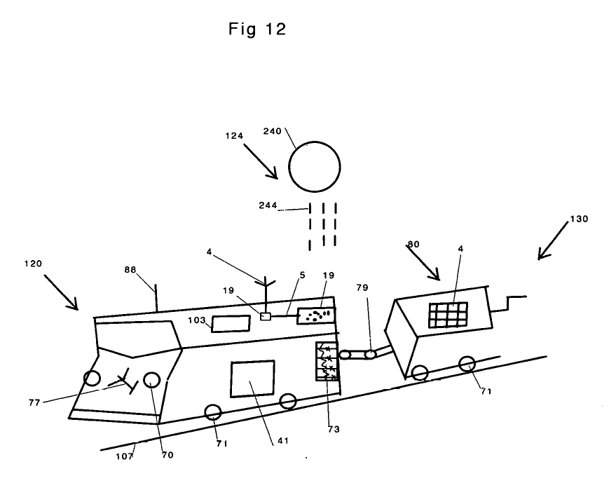

FIG. 12, illustrate a train, 120 demonstrating futures of the train, starting from the front are 70 front lights, wind shield wipes, shown is the train rails, at the top view of the embodiment is the navigational, or media exchange technology. Atop of the train is the climate control utility, 120 FIG. 12, illustrating from the side view is 41 the door, the train wheel 71 is below. (See FIGS. 4 to 6)

FIG. 12,124 demonstrated the 240 effect of diverse weather condition on 4 renewable energy, 80 it may be appreciate if the train require added parts, remote control or other electronic motor for repositioning of the 4 renewable energy, 73 motor engine may be add to the train, plus electric motor.

FIG. 12. Continue on FIG. 12 is the 2^{nd} train car, illustrated at the top view of the train is the hook up for both trains, further the 2^{nd} car in the train 4 have a solar panel, other train cars are attached.

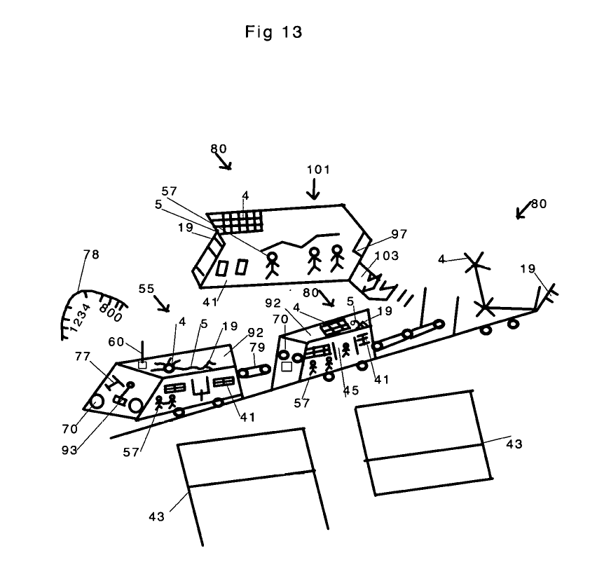

FIG. 13. illustrated in 55 the embodiment of FIG. 5 is a new train, 120 beginning from the front of the train is the 120 mount to the structures, the engine 73 could be any style engine, but preferable engine 73 is electric motor, there 70 is a pair of lights, at the 107 wind shield is the 77 wind shield wiper, 55 at the top of the new train is mounted and 16 for solid is 88 the train navigation sensors technologies. Beside 88 electronic and computer navigators, is 103 the compressor or air conditional system, closely located 45 are numerous locked or opened windows.

Continuing FIG. 13, also illustrate 130 at the top end of the rear end of the train 80 is mobile mounted and clipped to the train 16 with its elements are 4 the renewable energy (power station). Like 4 the wind turbine Sun solar system, water, heat, steam energy. It will be appreciated that the 55 train car shown on FIG. 5, may be one 79 car or many joined cars, pull together for larger farming, harvest, distributing goods, transporting people and goods. The 55 train 4 power station which could deliver well above 600 watts of electric power, (See FIG. 13, on 120 top of the train, (illustrating a part of the 78 dash board showing level of energy from the renewable energy source 19 have transmitter, 19 or transistor which reduces the currents in the 5 cables feed other appliances.)

As illustrated in FIG. 13, 55 the train 88 maybe equipped with autonomous 88 technologies for around 43 the clock farm harvest, goods and passenger (see FIG. 5 the brief description of the FIG. 5. An air plane inspect a farm) an air plane is called in to inspect the farm for potential bug troubles and telecast commutation or media to the train or the main office. Further below the rear 130 end of the 55 train is illustrated the 71 train wheels, 83 the shocks, the 41 door way is located 124 in the middle of the 55 train.

Continuing in FIG. 13, demonstrating a new 80 renewable energy power 55 train, the new train do not need a recharging stations, the 55 new trains do not need gas, diesel, Kerosene, the new train save money to the poor farm, improve farm productive, the new train save to the public and distribute good at less cost than the prior art train. At the upper level of FIG. 13, illustrated is a 101 station house, on the top of the 125 middle car, the station is connect to the 55 train by a 103 ramp or stair case, as shown 57 there is people bounding the train, the train is a multiple 79 cars pull train, the 80 renewable energy is also mounted in the station, the opposite side illustrate 43 a farm, shown in between the 43 farm areas is a new mobile 55 vehicle moving harvest to the 55 the train, the train deliver the harvest to the factory or shops for consumers for less customers or consumers. It may be appreciated that the train may be substituted, converted, adjust the assemble method to likes of ship, vehicle, plane, and helicopter (Not Shown).

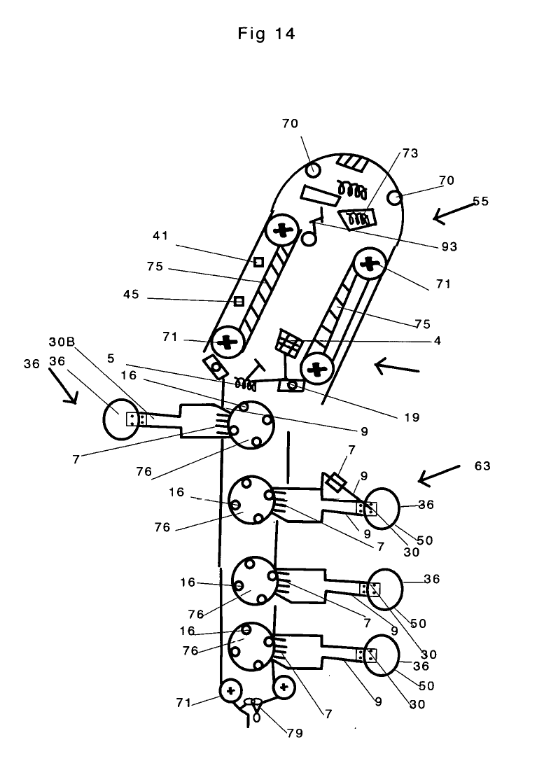

FIG. 14 illustrated in 55 the embodiment of FIG. 14 is a new mobile vehicle, 120 beginning from the front of the vehicle is the 120 mount to the structures, the engine 73 could be any assembled engine, but preferable engine 73 is electric motor engine and 4 energy source from renewable solar or wind Turbine other, there 70 is a pair of lights, at the 107 wind shield is the 77 wind shield wiper, 55 at the top of the new mobile vehicle is mounted 16 clips or clip body 16 for solid attachment of 88 the mobile vehicle navigation sensors technologies. Beside 88 electronic and computer navigators, is 103 the compressor or air conditional system, closely located 45 are numerous locked or opened windows, on the side is shown 71 a heavy chain wheels. In side the 55 vehicle, 100 seats, 83 breaks, 82 steering, and 78 dash board which holds all the vehicle media communications to the responsible driver, have 78 all the buttons to technically, and remotely operate the vehicle 73, break 93 or moving of the vehicle or parts like the 63 smart hole, or the parts of renewable 4 energy, (See FIG. 6).

Illustrating the 55 new vehicle, in the 124 embodiment, at the 124 second section of 55 the new vehicle is mounted 63 numerous new hoe technology, the new hoe technology is a newly designed 36 hoe technology for farm, the 36 new hoe at the lower end of the 36 hoe is design to dig-up, grind, clearing the 43 farm, the new 36 hoe could be one or multiple numbers, 36 in many design to meet all agricultural need, a rice farm need, a yam farm need, a corn farm need, a potatoes farm, a fish farm, or animal farm.

The 50 new hoe at the upper end is attached or clipped to 16 a bracket (other connectors) in flex connected 1^{st} end of a bracket, at 16 the 2^{nd} other end of 30c the bracket or other connector is connected, or clipped flexible, loop shape 30b of lower end of the 1^{st} arm, then the upper end 9 arm of the 1^{st} arm 9 is attach to the lower end of the 2^{nd} arm, the upper end of the 2^{nd} 10 arm is attached to the motor, piston or other electrical devices, it will be appreciated that the machine motor is collectivized device, see FIG. 2.

As mentioned 60 earlier and illustrated in FIG. 14. and seen in the 124 second pulled vehicle of the 55 new vehicle standing adjacent to 63 the new 36 hoe is a 2^{nd} 21 new hoe technology, the 2^{nd} hoe 6 is design 21 to mould the farm 43 bed for special crops, it will be appreciated to those learned or skilled in the art that the arrangement 9 of the arm 10, the arrangement of the 16 of the connectors, brackets, (inter connection of the nuts and screws) are similar, the 7 machines like electric motor, sensor or piston etc, are the same, See FIG. 2. the new hoe technology maybe mounted in any 55 part of the new vehicle. It will be appreciated that this method of assemble of the new hole technology and the pulling new vehicle maybe duplicated in other vehicles like motor bike, wheel Berol, folk lifter, wheel cat, train, ship. etc.

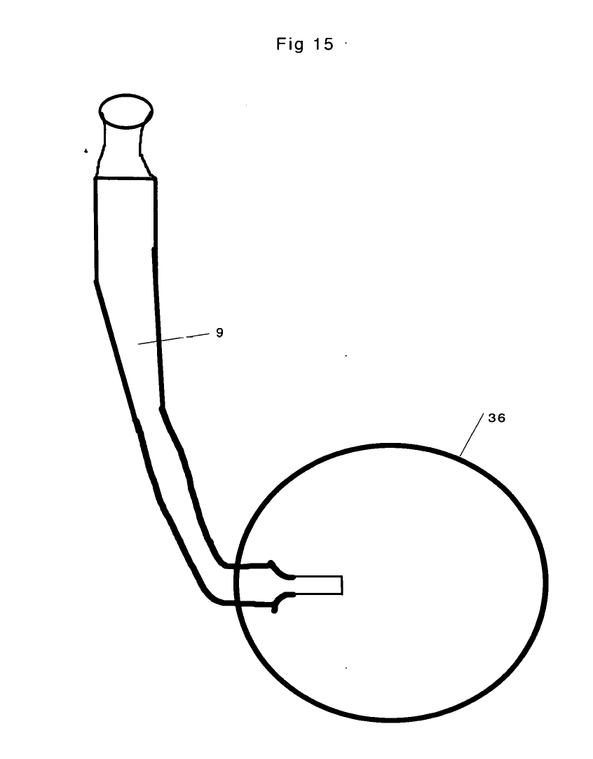

FIG. 15, FIG. 15, is illustrating the prior art, shown a wooden 9 arm and a metal hole, the process associated to this farm tools is it is 100 percent manual, cultivation is physical, planting is physical, harvesting is physical. 100 percent reliance on physical labor.

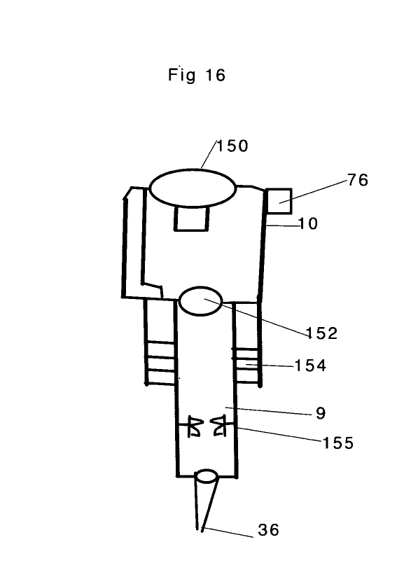

FIG. 16, is illustrating a simply mechanism for planting roots, stem, or yams, the planting item is 150 clip to the clip body lowed to the first 10 arm by hand or 76 machine to the second arm 9 where the yam is lowered to the 36 ground and instance get cut-out and planted, this 63 will be repeated until the entire farm is completely planted, there may be alternate arrangement to solve the deficiencies of the prior art illustrated in FIG. 15

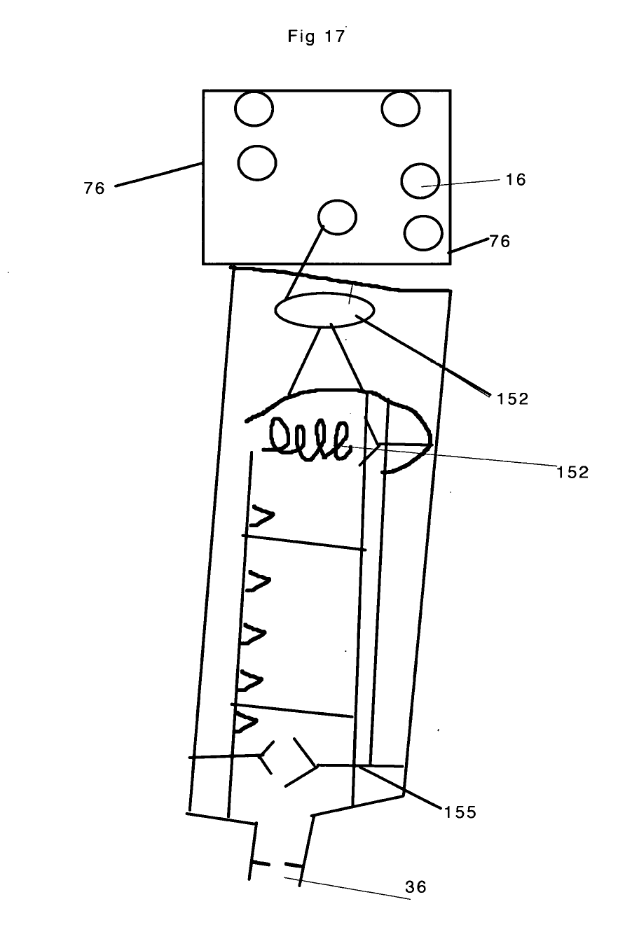

FIG. 17, is illustrating a simply mechanism for planting roots, stem, or yams, the planting item is 150 clip to the clip body lowed to the first 10 arm by hand or 76 machine to the second arm 9 where the yam is lowered to the 36 ground and instance get cut-out and planted, this 63 will be repeated until the entire farm is completely planted, there may be alternate arrangement, read below, this also solve the deficiencies of the prior art illustrated in FIG. 15

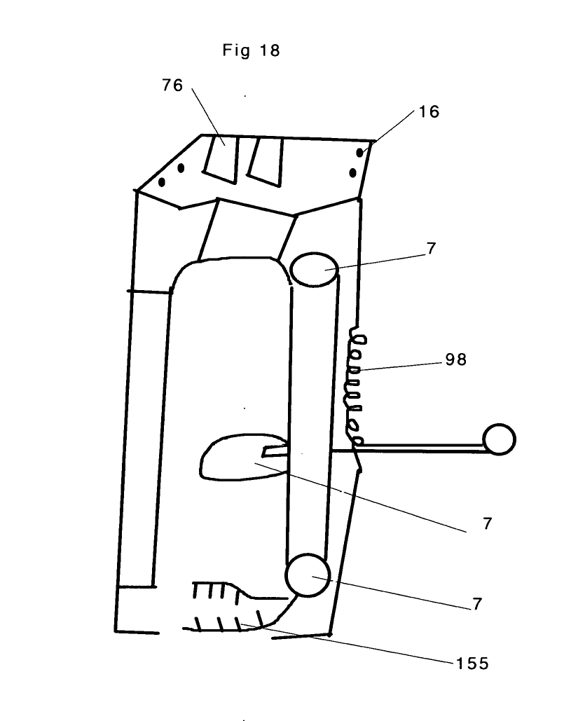

FIG. 18, like FIG. 16, and FIG. 17, maybe mount on a vehicle or hand held, FIG. 18 illustrate a hoe technology that plant yam, root, stem with a record fast, shown is 76 the flex clip, or clip body to mount 63 the hoe to a vehicle. The yam or stem or root clip body have a 7 motor, electronic, piston, vacuum. The new hoe maybe autonomous, 88 the planter is equip with sensors, memory, 4 power, time, activator, and technological enhanced 155 cut-out knife, FIG. 18, if reprogrammed can harvest the farm (Not Shown).

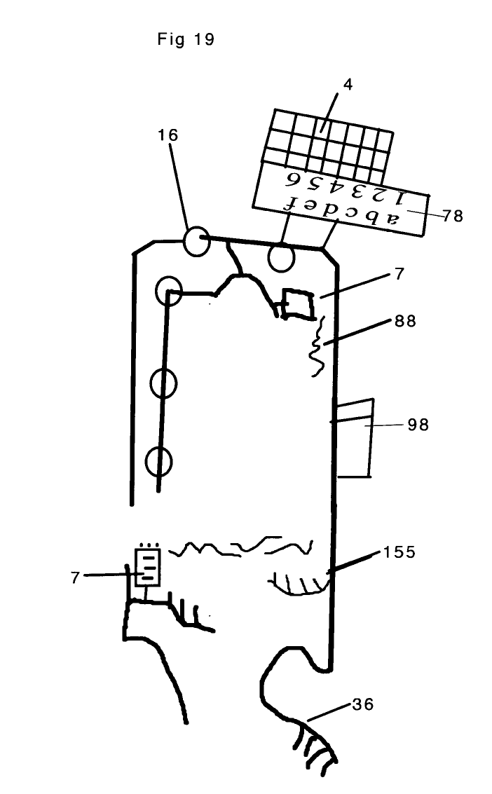

FIG. 19, is like FIG. 16, and FIG. 17, maybe mount on a vehicle or hand held, FIG. 18 illustrate a hoe technology that plant yam, root, stem with a record fast, shown is 76 the flex clip, or clip body to mount 63 the hoe to a vehicle. The seeds, yams or stem or root clip body have a 7 motor, electronic, piston, vacuum press machine. The new hoe maybe autonomous, 88 the planting machine or device is equip with sensors, or computer, electronic, camera memory, 4 power, time, activator, and technological enhanced 155 cut-out knife, FIG. 18, if reprogrammed can harvest the farm (Not Shown). FIG. 19 have a screen digital display of all the planting and harvesting activities, can exchange media, save or store media. It will be appreciated that this method of assemble of the new hole technology planter and harvest (new vehicle) machine maybe duplicated in other vehicles like trucks, motor bike, wheel Berol, folk lifter, wheel cat, train, ship and or helicopter and the likes. This will help famers of various reach to use the new technology to improve world food production.

FIG. 20, also illustrated 63 and describe is the 99 prior art 36 hoe, the prior art 99 hoe have only arm, the prior art hoe need a human strength to 10 function, the prior art hoe strength is limited, the 36 prior art hoe is limited by weather. A table list of deficiencies inherited from the 99 prior hoe are listed below, the prior hoe are carried to farm, 55 is not a new part of the new vehicle(s). See FIGS. 3 to 9 for the description of the new vehicle and it various features.

Deficiency of the Old Farm Hoe

1. Capacity is substance agriculture

2. Employ only the prior people now, Young people left

3. Low productive

4. cannot support export

5. Labor intensive

The New Farm Hoe Technology have Overcome Deficiency

1. Support commercialized farming

2. Support all ages, agenda, employment

3. Technology and or machine base employment

4. Less labor intensive

5. The system can support export and large industries

6. It is a mobile intensive farming

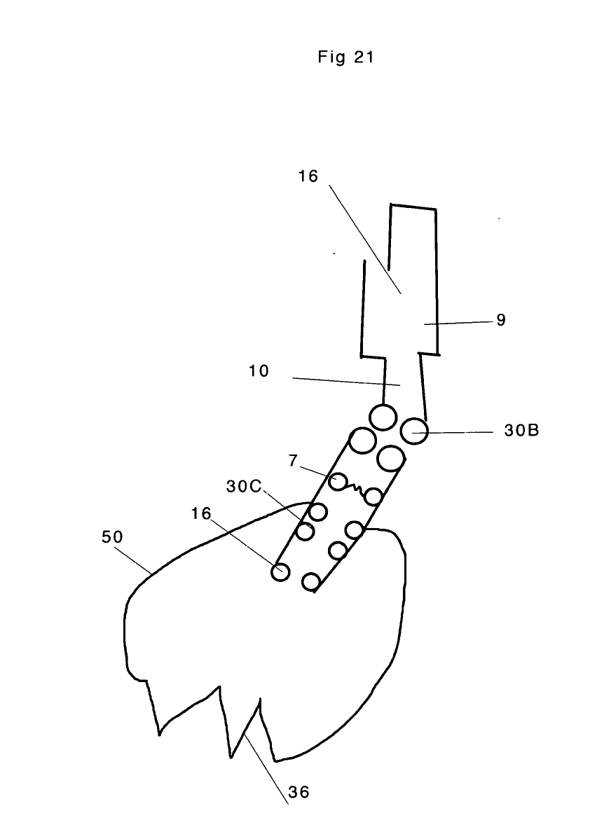

FIG. 21 illustrate 55 again the new feature of the new vehicle (new vehicles, not shown, see FIG. 3-9). The 63 assembling process illustrate 36 an adequate designed new hoe technology, 36 the device, 50 at upper end 50 the new hoe is a specially designed 16 bracket rather 30c clip in a bend loop or other means, onto 50 the upper end of the 30c new hoe technology. A lower end 30b of the 1st arm is attached 30c to the upper end of 50 the new hoe 16 in a flex nut for stability of 36 of the new hoe, the 30c the flex section 30b allow 36 the free 7 coordinated or technological programmed 43 farming. (Examples, the axillaries, up and down movement. See the demonstration on FIG. 2, Paragraph 4) The 9 upper end of the 1^{st} arm is attached to 30a the lower end of the 2^{nd} arm 10 In a flex bond for a similar coordinated or technological programmed move 36 of the hoe farming activities. The upper end of the 10 2^{nd} arm is clipped the 7 motor, it will be appreciated that the upper 7 end may assemble other machines like a vacuum, hydraulic, piston, renewable energy, electric or computer electronic devices, sensors, satellites, GPS, ETC.

As illustrated 80 in FIG. 21, it will be appreciated that the assemble process include a mobile clean energy sources to power the new farming hoe technology, the clean 4 energy sources include a mobile solar, turbine steam, etc. it will be appreciated the economical impact and relief to farmers this renewable energy sources. This mobile renewable energy source delivers current through 5 wires or cable to 19 a transmitter, or transistor or break circuit system (analog or digital).

The 80 the mobile 4 energy provide power to the new hoe assemble, or (any configuration of the arms or devices) 7 to the motor (see the above paragraph), the motor with a sensor or without a sensor coordinate the motion of the 9 arms to the 36 hoe up, down, swing, cycling, digging, shoveling, drilling, picking clearing, and other farm need.

The present invention and the embodiments have been described, it will be appreciated, it is evident to those skilled in the art that the invention may be embodied in other specific forms without departing from the essential charactistics thereof.

We claim:

1. A new mobile vehicle, ship, Train, or Air plane assemble, for people use, people and commercial. Farm use, others. The new mobile vehicle, train, ship, or helicopter is improved and adopted modern technology, including computer, and electronic, phone or cell phone, GPS or other satellite, or autonomous mobile technology.
The new mobile vehicle, ship, Train, cycle, bike cycle, air plane will be assembled and built Green, the new vehicle and others will be built under Green technology. The green technology include a solar technology, mobile built solar energy and its elements, mobile built turbine wind energy and elements, solar or other renewable energy heat energy and element.
The new vehicle and others mention is assemble with renewable energy described above, and coupled with an electric motor. The mention configuration eliminate charging station, battery may not be necessary, (seasonal in extreme weather), eliminate respiratory, and heart problem, the new vehicle does not need engine that raise emission and pollute the street with lead, carbon or carbon monoxide.
The new vehicle and other have a new farm hoe technology, the new farm hoe eliminate the previous labor intensive farm hoe to a hoe technology and high tech and less labor intensive farm hoe, the new hoe technology is a Green technology, the innovated hoe uses clear technology, renewable energy powers the hoe assemble,
The new hoe technology is inbuilt or attached, or embed or weld to the mobile vehicle and others, the arm(s) of the hoe and motor, piston, vacuum, hydraulic, other are powered by Green energy technology, or renewable energy resources.
Autonomous farming technology or non autonomous, but all method technologically support, the arm(s) mounted on the 1^{st} end of the motor, piston or others, mounted to the motor, piston or the others at the 1^{st} end of the arm, the 2^{nd} end of the 1st arm (s), upper end attach to a flex clip body and attach to the upper end of the hoe for farming activities, the motor, piston, or others manage the turns, rotation, vertical or horizontal movement of the hoe. There could be more arm or piston, motor in a different configuration, arrangements.

2. A new mobile vehicles according to claim one, where as the said clip or clip body is to mount, install, fix adjustment, modification, or departure from farm vehicle to personal vehicle is to fasten devices, items, engines, motors, piston, hydraulics machine, and others in the assemble of the vehicle, ship, train, bike, bicycle or and air plane.

3. A new vehicle according to claims 1 and 2 where as said vehicle energy system is a renewable energies like Solar, Turbine, heat, water, electronic, and computer device, or combination, and others.

4. A new mobile vehicle according to claims 1 to 3 whereas said vehicle is farm type with a new hoe technology mounted any where along the vehicle body, or attach parts or portion of the train, ship, bike and air plane

5. A new mobile vehicle according to claims 1 to 4 wherein the said hoes technology is clipped to an arm or arms for farm use, from mom and dad mills to corporate agro industrial farms.

6. A new mobile vehicle according to claims 1 to 5, whereas said arm, or arms may be axially, vertical, horizontal, revise, forward, backward, perform all farm movement using assembled electronics machine, computer, motor, hydraulic, Preston, vacuum, others including manual.

7. A new mobile vehicle according to claims 1 to 6, wherein said arm, arms or other forms of clipping along the body of the vehicle is equip with switches, buttons, remote control, computer and electronically configured autonomous farming, may be modified for a personal vehicle.

8. A new mobile vehicle according to claims 1 to 7, whereas said arm, arms, or others are clipped in any parts or portion of the vehicles or to bear on any attach vehicle part is a motor, computer, camera, and electronic assembled for farming operate on current and or electricity supplied by renewable energy source. Maybe modified for personal vehicle.

9. A new mobile vehicle according to claims 1 to 8, wherein said hoes technology maybe operated manual, robotically with proper technology design and assemble to the vehicle need.

10. A new mobile vehicle according to claims 1 to 9, whereas said hoes technologies are mainly use for agricultural farming, or construction of farm pond, chicken pond, pig pond, cattle pond, fish pond, sheep pond, crab, snail, all animal, vegetable, and sea food ponds. New hoes technology maybe modified for the construction of the ponds or animal, vegetable and sea food habitants

11. A new mobile vehicle according to claims 1 to 10, whereas said arm or arms at the top maybe equip with clip body, flex bearers that allow changes, adjustment, or modification of different hoes around the arm. The new vehicles, hoes, and the technology maybe made from materials consistent with metal, steel, rubber, plastic, aluminum, wood, technology, glass, and combination, or others.

12. A new mobile vehicle according to claims 1 to 11, whereas said hoe technology elements are the platform, the arm/arms, the base, clip or and clip body, and the hoes.

13. A new mobile vehicle according to claims 1 to 12, whereas said hoe technology is a unitary system of assembly. The unitary system provide better solution to mom and dad mills, cooperative farms to corporation agro farm system, each to there farm size and need, vehicle, bike, bicycle, train, air plane.

14. A new mobile vehicle according to claims 1 to 13, whereas said vehicle, bike, bicycle, train, ship, air plane are provided with hoe technology in various positions along air plane etc, arms or arm.

15. A new mobile vehicle according to claims 1 to 14, whereas said hoe include a planter, a harvester, hoes that dispense medicine to animal and sea food habitants, this hoes maybe robotic, or autonomous.

16. A new mobile vehicle according to claims 1 to 15, wherein said renewable energy is a very important part of the invention, the renewable energy system may be in unitary assemble form. The renewable energy system maybe modified for animal, vegetable, sea or personal use.

17. A new mobile vehicle according to claims 1 to 16, whereas said energy resource from a renewable source from solar energy, turbine, heat, water, clean fluids technology, electronic, computer, buster technology system, and their elements, wire, transmitter, transistor, meter, magnet, amplifiers. Others, or combination off.

18. A new mobile vehicle according to claims 1 to 17, whereas said renewable energy assembled maybe independently install in a vehicle as a unit, or combination of units.

19. a new mobile vehicle according to claims 1 to 18, whereas said renewable energy mounts may be an arm or arms type, or a box type, or any other mount type with it elements, shape and size, clip to any parts, or portion vehicle.

20. a new vehicle according to claims 1 to 19, whereas the renewable energy mounts may be fix. Embed at the base, other part of the mounts clip to adjust position along the base, or vehicle.

21. A mobile vehicle according to claims 1 to 20. Mainly is a equip with motor mount, mounts for all the devices, frame, trims, body parts, openings for glass, and lights, air condition, tires, seats, shock, and springs, steering, dash board, electronics and computer technology, breaks and or leg vehicle control paddles, doors, hood, truck, engine, renewable mount, renewable energy, modified to farm vehicle, a hoes technology, and an arm technology, elements and the clip method.
